(19) United States
(12) Patent Application Publication
(10) Pub. No.: US 2003/0210555 A1
(43) Pub. Date: Nov. 13, 2003

(54) Decorative lighting apparatus and method

(75) Inventors: Gregory C. Cicero, Shaker Heights, OH (US); Mathew L. Sommers, Sagamore Hills, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: GELcore, LLC, Valley View, OH

(21) Appl. No.: 10/063,667

(22) Filed: May 7, 2002

(51) Int. Cl. F21L 2/00

(52) U.S. Cl. 362/555; 362/157

(57) ABSTRACT

A decorative lamp (10, 100) is disclosed for producing a diffuse or scattered lighting. A container (12, 102, 116) includes a light transmissive portion (18). A light source (20, 104, 118, 120, 150) includes a housing (32, 122, 152) arranged inside the light transmissive container (12, 102). The housing (32, 122, 152) includes a battery compartment (52, 130, 162) electrically and mechanically adapted to receive at least one associated battery. At least one LED (36,38, 126, 128, 158) is disposed on a first side (34) of the housing (32, 122, 150) and cooperates with the container (12, 102) to emit diffuse or scattered light from the light transmissive portion (18). A fastening means (62, 134) is arranged on a second side (60) of the housing (32, 122). The fastening means (62, 134) is provided to fasten the housing (32, 122, 150) to an inner side (76) of the container (12, 102) wherein the at least one LED (36, 38, 126, 128, 158) illuminates the interior of the container (12, 102).

### BACKGROUND OF INVENTION

The present invention relates to the lighting arts. It is especially applicable to decorative holiday lighting such as Halloween jack O'lanterns and Christmas luminarias or farolitos, and will be described with particular reference thereto. However, the invention will also find application in other lamps employing diffuse or scattered lighting or decorative lighting including a flickering effect.

Many types of decorative holiday lighting traditionally involve a light transmissive decorative container substantially surrounding or enclosing a candle. One example is the jack O'lantern, which includes a hollow pumpkin with carved openings inside which a candle is placed. Traditionally, the carved openings define a representation of a face, although other symbols or representations are sometimes carved. In a usual method for constructing a jack O'lantern: a top portion including the pumpkin stem is removed; the pumpkin is hollowed out through the opening formed by removal of the top portion; openings defining the face representation are carved on a selected side surface; a candle is placed inside the hollow pumpkin and lighted; and the top portion is replaced.

Another traditional decorative holiday lighting is the luminaria, sometimes also called a farolito, e.g., in New Mexico, where they are particularly popular. A luminaria includes a lighted candle placed inside a translucent bag. Typically, a small brown paper bag of a type commonly used for transporting retail purchases is employed.

The use of a candle in these holiday decorations can be problematic. Candles have limited operating life and fail when the usable candle wax is consumed by the flame. Candles can also be messy, because as the wax melts it tends to drip or ooze onto supporting surfaces. Candies are also potentially dangerous. They pose a burn hazard to the person lighting the candle. Candles present a very serious fire hazard, particularly when placed into a flammable paper bag. The fire hazard is increased by the traditional placement of jack O'lanterns and luminarias outdoors, where they are prone to malicious vandalism and capricious wind effects.

To overcome some of the aforementioned limitations, it is known to replace the candle with an incandescent electric light source. For example, U.S. Design Pat. No. D454,967 issued to Brown and Hennessey discloses a dome-shaped jack O'lantern light source with five incandescent light bulbs. The device is designed to be placed inside a jack O'lantern to replace the traditional candle. Incandescent luminarias are also known. These typically employ a translucent hard resin container mimicking the traditional brown paper bag. The resin container provides mechanical support for an incandescent light bulb arranged therein.

In spite of the availability of the aforementioned commercial products, candles continue to be widely used in jack O'lanterns, luminarias, and other decorative holiday lighting. Candles have a strong aesthetic appeal which incandescent electric light sources often cannot mimic successfully. In particular, candles produce a warm color tone and a randomly varying light intensity (candlelight flicker) which is difficult to reproduce using an incandescent electric light bulb. Light bulbs are also problematic in that they are energy inefficient. Since jack O'lanterns and luminarias are usually displayed outdoors, the low energy efficiency is particularly disadvantageous. If battery power is used, the battery life is limited. Alternatively, if house electricity is used, the light then includes an unsightly electrical cord, has a limited range of placement, and can be an electrical or fire hazard.

The present invention contemplates an improved apparatus and method that overcomes the above-mentioned limitations and others.

### SUMMARY OF INVENTION

In accordance with one embodiment of the present invention, a light is disclosed for lighting an interior of an associated container. The container includes at least one of a light transmissive surface and a light transmissive opening. The light includes a housing arrangeable inside the associated container. The housing including a means for receiving electrical power. The light also includes at least one light emitting diode arranged on a first side of the housing and electrically connected therewith for receiving energizing electrical power. The at least one light emitting diode produces illumination when energized. The light further includes a fastener arranged on a second side of the housing. The fastener is adapted to secure the housing to an inner side of the associated container.

In accordance with another embodiment of the present invention, a lamp is disclosed for producing a diffuse or scattered lighting. A container includes a light transmissive portion. A housing is arranged inside the light transmissive container. The housing includes a battery compartment electrically and mechanically adapted to receive at least one associated battery. At least one LED is disposed on a first side of the housing and cooperates with the container to emit diffuse or scattered light from the light transmissive portion. A fastening means is arranged on a second side of the housing. The fastening means is provided to fasten the housing to an inner side of the container wherein the at least one LED illuminates the interior of the container.

In accordance with yet another embodiment of the present invention, a method for providing indirect illumination is disclosed. Electron-hole pairs are electrically generated in a semiconducting material. The light produced by radiative recombination of the electron-hole pairs is diffused by interacting the light with a container that substantially surrounds the semiconducting material. The diffused light is emitted through a light transmissive portion of the container.

One advantage of the present invention is that it provides a low voltage and energy efficient solution for outdoor holiday lighting.

Another advantage of the present invention resides in the ability of light emitting diodes, alone or in combination, to provide a selected color tone or hue.

Another advantage of the present invention resides in a realistic rendering of candlelight flickering without resort to an open flame.

Another advantage of the present invention resides in a decreased amount of heat generated, which enables the device to operate in environments where heat is detrimental, such as in ice sculptures.

Yet another advantage of the present invention resides a substantial flexibility in the placement and orientation of the light source within an associated container.

Still yet another advantage of the present invention resides in combining an artificial light having illumination characteristics closely mimicking candlelight in a high efficiency, low voltage, and conveniently mountable package.

Numerous other advantages and benefits of the present invention will become apparent to those of ordinary skill in the art upon reading and understanding the following detailed description.

### BRIEF DESCRIPTION OF DRAWINGS

The invention may take form in various components and arrangements of components, and in various steps and arrangements of steps. The drawings are only for purposes of illustrating preferred embodiments and are not to be construed as limiting the invention.

FIG. 1 shows a schematic view of a jack O'lantern formed in accordance with one embodiment of the invention, including a first embodiment of an LED-based light source.

FIG. 2 shows an overhead view of the LED-based light source of FIG. 7.

FIG. 3 shows a perspective view of the LED-based light source of FIG. 7.

FIG. 4 shows a first side view of the LED-based light source of FIG. 7.

FIG. 5 shows a second side view of the LED-based light source of FIG. 7.

FIG. 6 shows an electrical schematic of an exemplary electronic energizing circuit for producing a periodic flickering effect.

FIG. 7 shows an electrical schematic of an exemplary electronic energizing circuit for producing a random flickering effect.

FIG. 8 shows an electrical schematic of an exemplary electronic energizing circuit for producing a random flickering effect and for providing an automatic deenergizing of the LEDs after a selected time period.

FIG. 9 shows two energized jack O'lanterns formed in accordance with an embodiment substantially similar to those illustrated in FIGS. 7-8.

FIG. 10 shows a partially exploded schematic view of a luminaria formed in accordance with an embodiment of the invention.

FIG. 11 shows an ice sculpture formed in accordance with an embodiment of the invention.

FIG. 12 shows an overhead view of an embodiment of an LED-based light source having a disk-shaped housing.

FIG. 13 shows a side view of an embodiment of an LED-based light source having a hook-and-loop fastener.

FIG. 14 shows a side view of an embodiment of an LED-based light source having an array of LEDs.

### DETAILED DESCRIPTION

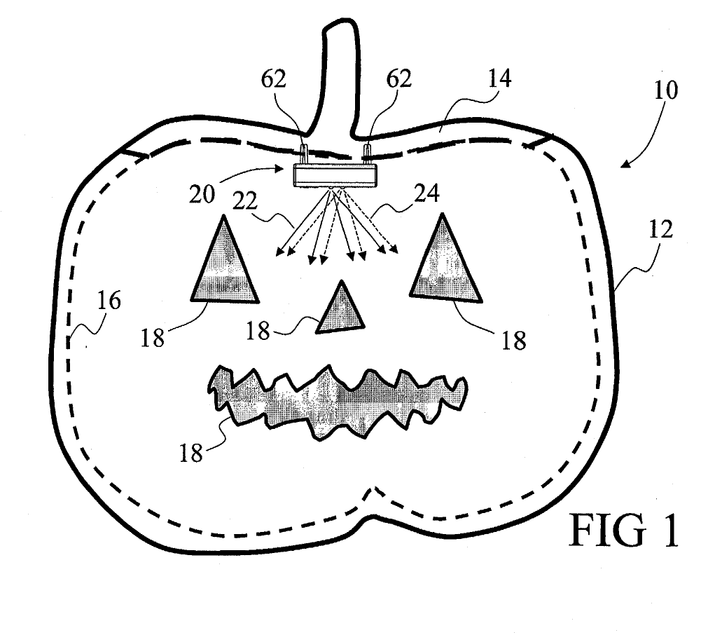

With reference to FIG. 1, a jack O'lantern 10 is made from a hollow pumpkin 12. A top portion 14 of the pumpkin has been cut out (cutting delineated by a long-dashed line) and the pumpkin 12 has been hollowed out through the opening exposed by removal of the top portion 14 to define an inner surface 16 (indicated by a short-dashed line). A plurality of openings 18 defining a face representation have been cut into the hollow pumpkin 12. Of course, other representations can be carved therein rather than (or in addition to) a face representation. Although an exemplary pumpkin-based jack O'lantern 10 is shown, it is to be appreciated that the jack O'lantern could be similarly constructed using another type of fruit or vegetable such as a squash, a gourd, or the like. In yet another suitable embodiment, a plastic or other artificial container, preferably formed to mimic a hollow carved pumpkin, can replace the natural hollow carved pumpkin 12.

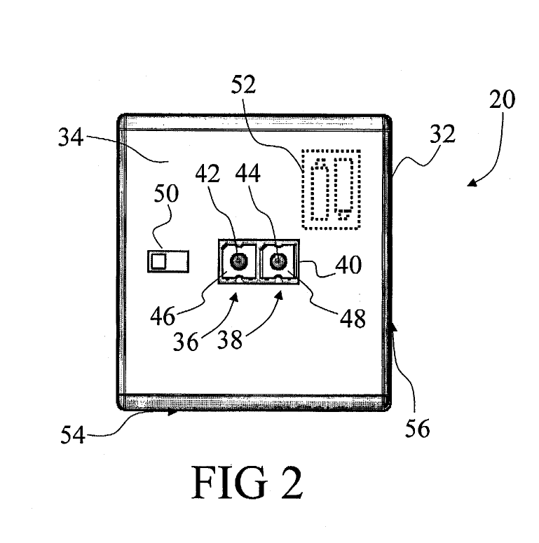

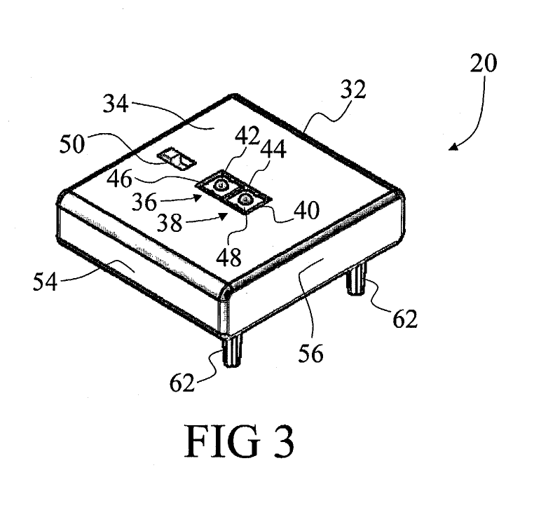

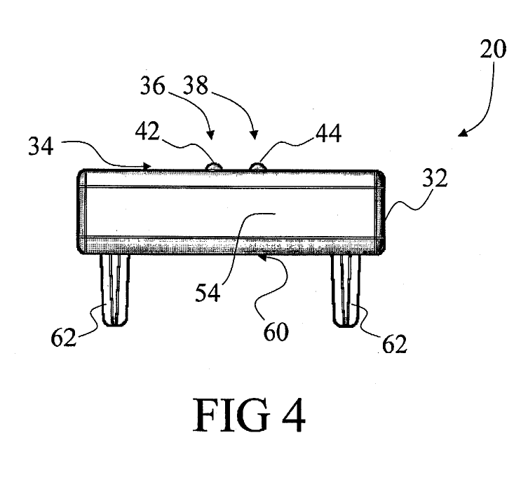

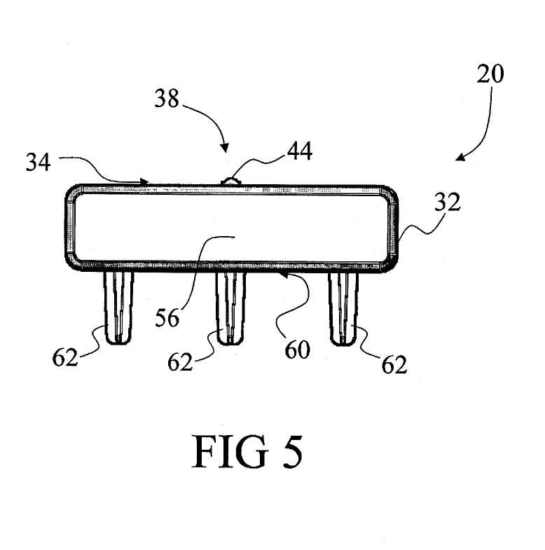

With continuing reference to FIG. 1 and with further reference to FIGS. 2-5, a light source 20 is disposed on the top portion 14 of the hollow pumpkin 12. The light source 20 includes a housing 32 having a first side 34 on which two light emitting diodes or LEDs 36, 38 are arranged in a recess 40 of the housing 32. Each LED 36, 38 includes a semiconducting chip 42, 44 arranged on separate lead frames 46, 48. The LEDs 36, 38 produce light 22, 24 (schematically represented by solid and dashed arrows, respectively, in FIG. 1) when energized by an electrical The energizing electrical current generates electron-hole pairs that subsequently radiatively recombine to produce the illumination 22, 24. An on-off switch 50 permits a user to manually effectuate energizing and deenergizing of the LEDs 36, 38. The housing 32 additionally includes a battery compartment 52 (shown in phantom in FIG. 2) containing associated batteries which provide electrical power. In a suitable embodiment, two to four type AA dry cell batteries, or two to four type AAA dry cell batteries, are mechanically and electrically received by the battery compartment 52. Of course other battery types can be employed, as well as other power sources such as house electricity, stored photovoltaic power, or the like.

In a preferred embodiment, a paired LED combination 36, 38 in which one LED 36 produces amber illumination 22 while the other LED 38 produces red illumination 24 suitably approximates the warm yellowish glow that is characteristic of candlelight. To effectively blend the red and amber colors, the LEDs 36, 38 are arranged on the first side 34 close together in the recess 40. A suitable semiconducting chip 42, 44 for red or amber illumination includes a group III-phosphide layered semiconducting material which includes an active region such as: an active layer; a plurality of active layers forming a multi-quantum well structure; a compositionally graded p/n junction active region; or other light-emitting structure. The group III-phosphide semiconducting materials include InP, AlP, GaP, and alloys of two or all three of these binary compounds. The active region of each of the two LEDs 36, 38 contain a selected group III-phosphide alloy which produces the desired illumination, e.g. red illumination, amber illumination, yellow illumination, or some mixture, color tone or hue thereof.

The described LED configuration is exemplary only. For other decorative lighting applications, different LEDs may be preferable. The phosphide-based LEDs are available at least in red, yellow, and green hues. Arsenide-based LEDs are well-suited for many reddish hues. For shorter wavelengths such as for blue illumination, a nitride-based LED is suitable. Furthermore, the LEDs can include selected phosphor coatings to obtain selected color components. Suitable white LEDs include a nitride-based LED that emits ultraviolet radiation which is converted into white light by a coating, epoxy, resin, or the like containing selected phosphors. Similarly, the number of LEDs can be varied as desired to the extent electrical power and/or room is available, and can range from a single LED to an array of LEDs which substantially covers the area of the first side 34. It is also contemplated to arrange LEDs on other sides of the housing 32, such as on the sides 54, 56.

With continuing reference to FIGS. 1-5, the housing 32 includes a second side 60 on which a fastener is arranged. In the illustrated embodiment the fastener includes three fastening prongs 62. As best seen in FIG. 1, the prongs penetrate and secure into the inner surface of the top portion 14 as the light source 20 is pressed into the top portion 14. In the illustrated embodiment of FIGS. 1-5, three prongs 62 are shown. However, different numbers of prongs can also be included. Enough prongs should be included to securely hold the light source 20 onto the inner surface 16. Optionally, the prongs can include hooks, barbs, or other projections to help in the securing. Furthermore, the prongs 62 are optionally replaced by other fastening means, such as a clip a magnet, tap, adhesive, or a hook-and-loop fastener. The illustrated attachment of the light source 20 to the top portion 14 is particularly convenient because the inner surface of the top portion 14 is easily accessed by removing the cut-out top portion 14 from the remainder of the hollow pumpkin 12. However, it will be appreciated that the fastener 62 can also attach the light source 20 to a side portion or bottom portion of the hollow pumpkin 12.

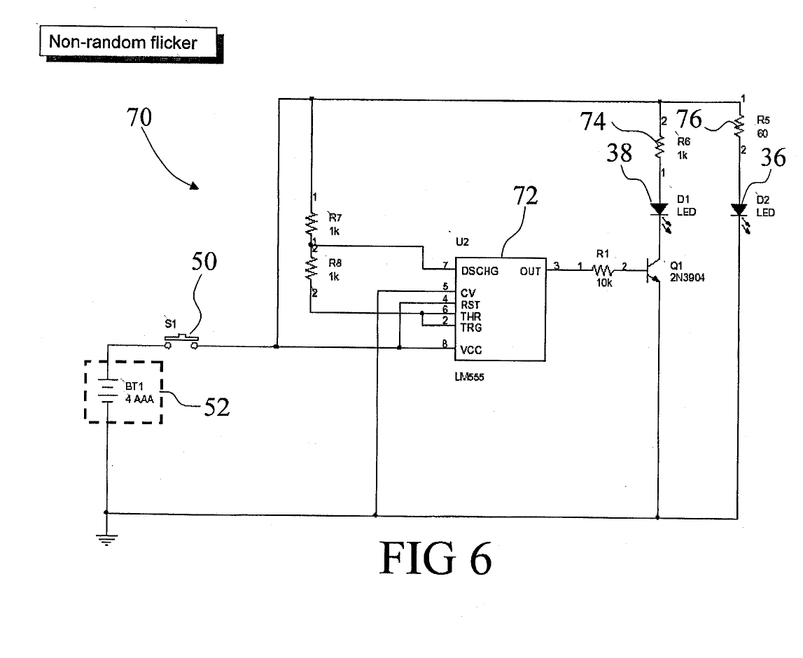

With continuing reference to FIGS. 1-5, and with further reference to FIG. 6, one or more batteries in the battery compartment 52 energize the LEDs 36, 38 through appropriate circuitry contained in the housing 32. An exemplary circuit 70 shown in FIG. 6 produces a periodic modulation of the red illumination 24 produced by LED 38 and a constant amber illumination 22 produced by LED 36 that cooperate to closely mimic flickering candlelight. The circuit 70 provides a constant power input to the amber LED 36, but the power input to the red LED 38 is modulated in a periodic fashion using a timer 72 (e.g., an LM555 timing chip available from National Semiconductor Corp.) in cooperation with resistive and transistive circuit elements. The relative resistances of the resistors 74, 76 are selected to achieve a desired intensity blending of the constant amber illumination 22 and the periodically varying illumination 24. The arrangement 70 has been found to effectively mimic the flickering of typical candlelight. By swapping the LEDs 36, 38 in the circuit 70 shown in FIG. 6 and suitably adjusting the resistive and transistive element parameters, a periodically flickering blood red illumination can be obtained. This blood-red illumination is particularly suitable for certain Halloween settings. Of course, other color combinations may also be used to obtain similar effects as desired for given applications.

With continuing reference to FIGS. 1-5 and with further reference to FIG. 1, another exemplary circuit 80 is shown. The circuit 80 employs a microcontroller 82 (e.g., a PIC12C508 microcontroller available from Microchip Technology Inc.) with suitable program instructions and cooperating resistive and transistive elements to effectuate a constant energizing of the amber LED 36 and a randomly varying energizing of the red LED 38. This circuit mimics the flickering illumination of candlelight including the random aspect of candlelight flickering. A suitably designed application-specific integrated circuit (ASIC) can be substituted for the microcontroller 82.

Those skilled in the art will recognize that the energizing sub-circuits for the LEDs 36, 38 are symmetric. Hence, by changing only the software instructions, an alternative constant energizing of the red LED 38 and a randomly varying energizing of the amber LED 36 can be obtained to produce a flickering blood red illumination. In general, each of the LEDs 36, 38 can be made to periodically flicker, randomly flicker, produce a constant illumination, or have another illumination intensity variation. It is also contemplated to include a switch or other selector electrically coupled with the microcontroller 82 which allows the user to select between two or more different illumination modulations. It will also be appreciated that a single LED having a color characteristic substantially similar to that of candlelight can be made to flicker periodically, randomly, or otherwise to provide an approximation of candlelight flickering.

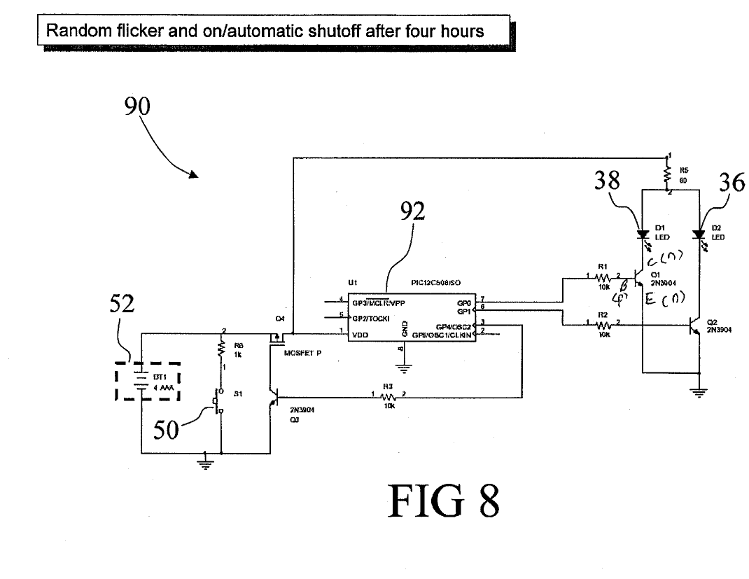

With continuing reference to FIGS. 1-5 and with further reference to FIG. 8, yet another exemplary circuit 90 is shown. The circuit 90 employs a microcontroller 92 (e.g., a PIC12C508 microcontroller) and cooperating resistive and transistive elements to effectuate a constant energizing of the amber LED 36 and a randomly varying energizing of the red LED 38, and also to effectuate automatic deenergizing of the LEDs 36, 38 after a selected operating interval, e.g. after four hours. The circuit 90 closely mimics the random flickering illumination of candlelight. Furthermore, by employing the circuit 90 in the light source 20, the user can turn on the light source 20, e.g. in the evening, using the manual on/off switch 50, secure in the knowledge that the light source 20 will automatically shut off to conserve battery life after operating for the designated period. The jack O'lantern 10 thus can be turned on at nightfall, i.e. about 7:00 p.m. or so, and can be made to automatically shut off around bedtime at 11:00 p.m. Of course, those skilled in the art can readily change the selected operating interval by making selected modifications to the circuit parameters of the circuit 90. Optionally, the timing circuit effectuates both an automatic energizing of the LEDs 36, 38 at a preselected turn-on time followed by an automatic deenergizing of the LEDs 36, 38 at a preselected turn-off time.

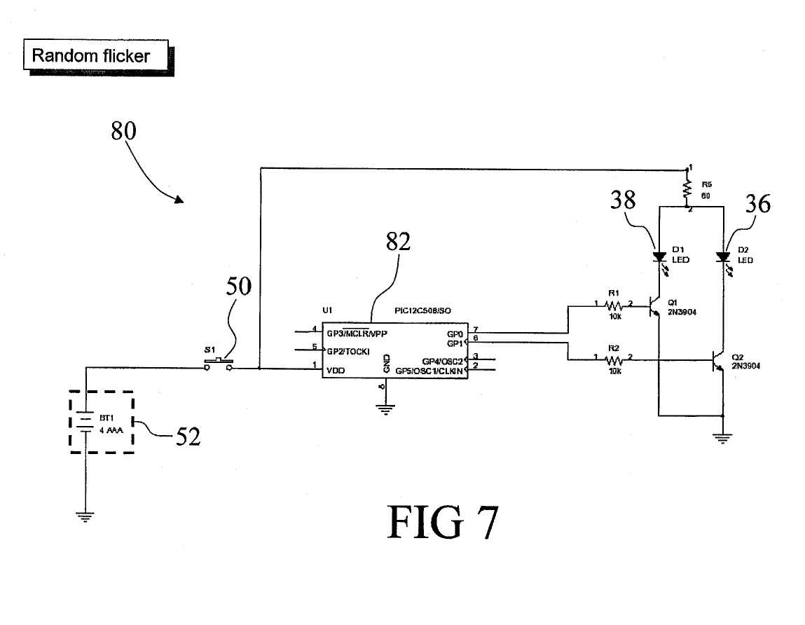

The circuits 70, 80, 90 of FIGS. 6-8 are exemplary only. Those skilled in the art can readily construct other circuits which are suitable for other selected arrangements of LEDs and other selected decorative lighting applications. For example, circuits appropriate for different color combinations and/or for producing different illumination modulation effects such as random and/or periodic on/off intensity variations are contemplated. Similarly, different automatic shut-off capabilities or an automatic timer activation capability are also contemplated, such circuit design being well within the abilities of those of ordinary skill in the art.

With particular reference to FIG. 1 , the illumination 22, 24 generated by the light source 20 illuminates the interior of the jack O'lantern 10. In particular, the illumination 22, 24 impinges upon and diffusely reflects or scatters from the inner surfaces 16. The reflecting or scattering further blends the red and amber illumination 22, 24 to effectuate the desired color, hue, or tone. A fraction of the reflected or scattered light impinges multiple times on the inner surfaces 16. Although some of the light is absorbed at the inner surface 16, a substantial portion of the reflected or scattered light reaches one of the openings 18. This light portion exits the jack O'lantern 10 through the openings 18 to illuminatingly define the face or other representation carved therein. The light source 20 diffusely illuminates the openings 18. Preferably, the light source 20 is arranged at the top portion 14 or in another position within the hollow pumpkin 12 where it is not directly visible through the openings 18.

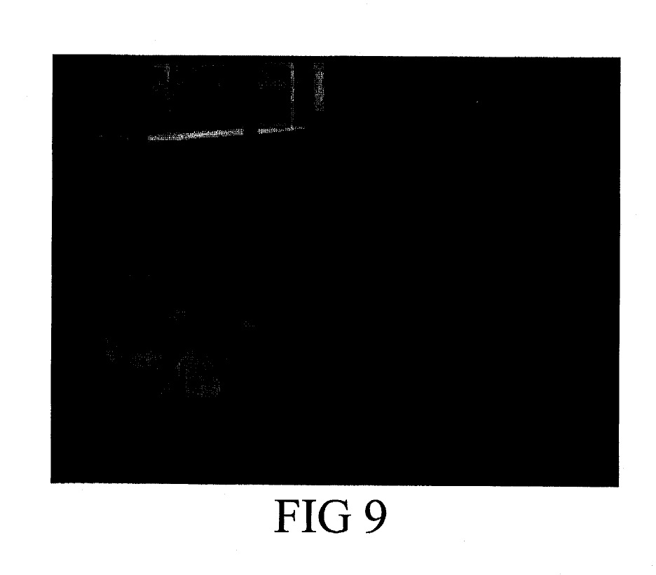

FIG. 9 shows a photograph of two operating jack O'lanterns formed in accordance with the embodiment schematically shown in FIG. 1. The diffuse lighting is clearly seen emanating from the openings defining the face representation, in accordance with the usual operation of a jack O'lantern. In testing, the jack O'lanterns shown have been operated for 31 hours continuously, running on four AAA-type batteries, without discharging the batteries. In contrast, one commercial electric incandescent light source marketed for use in jack O'lanterns was found to discharge its batteries and hence cease operation in about 6 to 10 hours under similar operating conditions. Preferably, the battery compartment 52 (FIG. 2) includes a door, opening, or the like (not shown) for accessing and replacing the associated batteries when they are discharged.

Although an exemplary jack O'lantern is shown in FIG. 1, it is to be appreciated that other types of containers can be employed for other decorative lighting applications. Reduced heat generation of LEDs versus incandescent sources, coupled with the wide range of colors, color combinations, and different illumination modulation effects obtainable using LEDs, are beneficial in many such decorative lamps. For example, at a special occasion dinner, a lighted fruit, vegetable, or similar produce item other than a hollow pumpkin may be preferred as a table decoration. The light source 20 uses LEDs which dissipate less heat than incandescent sources. Hence, the light source 20 will heat the lighted produce less than an incandescent source, which in turn can reduce thermally generated odors, gas emissions, discoloration, and the like. Furthermore, LEDs are compact and draw limited electrical power, and so the LED light source 20 can be made quite small.

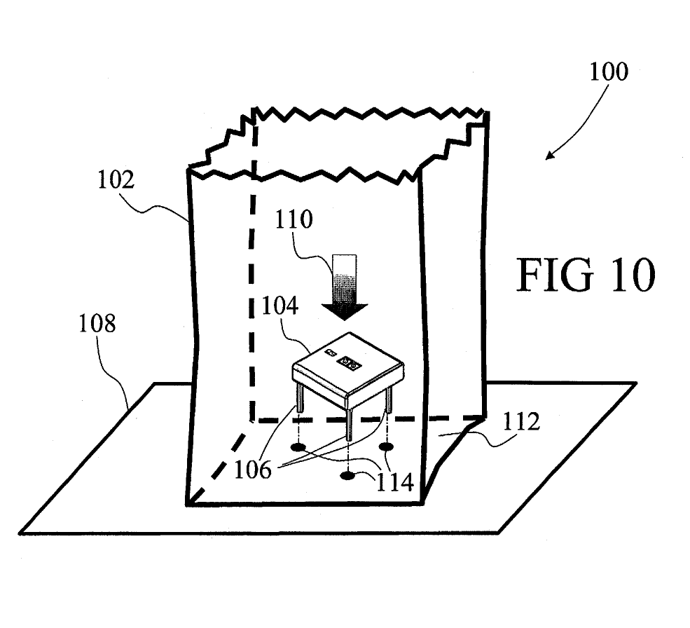

With reference to FIG. 10, a luminaria 100 includes a brown paper bag 102 and a light source 104 which is substantially similar to the light source 20 previously described with reference to FIGS. 1-8, except that the light source 104 has longer fastening prongs 106. The brown paper bag 102 rests on a surface 108 which for example is a grassy lawn outside of a house. The light source 104 is pressed down 110 (force schematically indicated by an arrow) in the orientation shown, so that the prongs 106 puncture a bottom portion 112 of the brown paper bag 102 to form puncture holes 114 in the bottom portion 112 through which the prongs 106 pass. The pressing 110 continues to force the prongs downward into the ground 108 to secure the light source 104 to the bottom portion 112 of the brown paper bag 102 and to secure both the bag 102 and the light source 104 to the ground or surface 108.

In a suitable embodiment, the light source 104 uses the same red/amber LED combination as the jack O'lantern light source 20 to closely mimic the traditional candlelight illumination of luminarias. A circuit selected from the circuits 70, 80, 90 is employed in the light source 104 to mimic candlelight flickering. In another suitable embodiment, a red or a green LED is used, since these are traditional Christmas colors. In yet another suitable embodiment, red and green LEDs are included on the light source 104. Of course, those skilled in the art can select other numbers, colors, or types of LEDs and/or build different driving circuits effectuating various illumination modulation effects or the like as desired for a specific luminaria application.

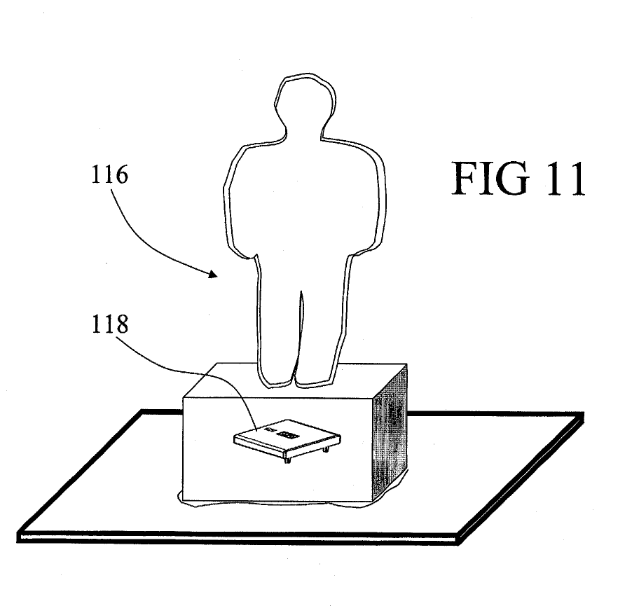

With reference to FIG. 11 , an ice sculpture 116 includes an LED light source 118 embedded within the ice. The LED light source 118 includes one or more LEDs and is substantially similar to the light source 20, except that the fastening prongs are shortened or optionally omitted. The light source 118 is also preferably water-tight or sealed to prevent fluid contamination. In a typical construction, the ice sculpture 116 is formed in a usual manner, except that the light source 118 is arranged into a selected position during freezing. In another suitable embodiment, an extended recess can be formed into the ice and the light source 118 inserted. Because ice sculptures are typically short-lived displays, in one suitable embodiment the light source is turned on before being frozen into place. In another embodiment, the light source 118 includes a receiver (not shown) and energizes the one or more LEDs responsive to receipt of an infrared, radio or other like signal. It is also contemplated to include a DMX or other type of controller which permits additional remote control beyond energizing and deenergizing. For example, a plurality of colored LEDs can be color-controlled using a DMX or other similar controller.

Because typically LEDs run cooler than incandescent sources, a decreased amount of heat is generated, which enables the light source 118 to operate in the ice sculpture 116 without substantially accelerating the melting thereof. The one or more LEDs can be of any selected color or color combination, such as a cool blue color which accentuates the ice sculpture appearance, or a patriotic red, white, and blue LED combination. The crystalline structure of the ice sculpture 116 cooperates with illumination produced by the LED light source 118 to produce an aesthetically pleasing illuminated ice sculpture display. It will also be appreciated that the light source 118 is optionally retrieved and reused after the ice sculpture 116 fully melts.

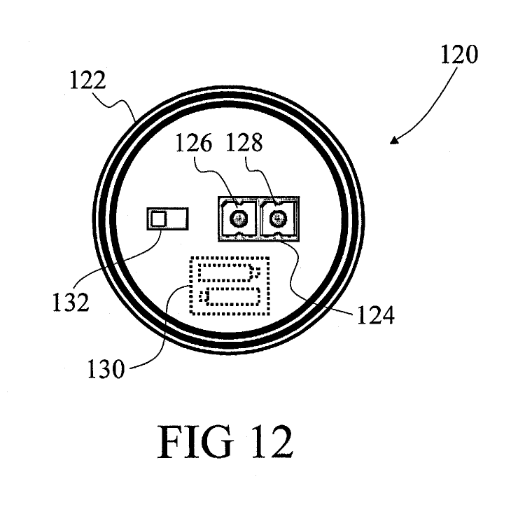

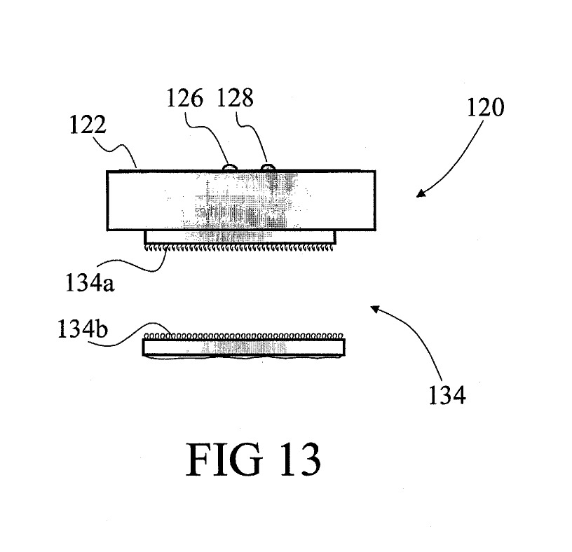

With reference to FIGS. 12 and 13, a round light source 120 includes a disk-shaped round housing 122 having a recess 124 in which amber and red LEDs 126, 128 are arranged. The housing 122 also contains electronic circuitry substantially similar to a selected one of the circuits 70, 80, 90 and a battery compartment 130 (shown in phantom) that mechanically and electrically receives associated batteries for powering the LEDs 126, 128 via the selected circuit responsive to device activation using an on/off switch 132.

The light source 120 also includes a hook-and-loop type fastener 134 (e.g., a Velcro® fastener available from Velcro Industries B.V.). The fastener 134 includes a hook pad 134a glued or otherwise adhesively attached to the housing 122, and a loop pad 134b adapted for gluing or otherwise adhesively bonding to an inner surface of an associated container into which the disk-shaped light source 120 is to be arranged. The hooks and loops of the pads 134a, 134b cooperate to effectuate detachable fastening of the light source 120 to the inner surface onto which the loop pad 134b is bonded. If the associated container has a magnetic inner surface, the hook pad 134a is optionally replaced by a magnet that is glued, bolted, or otherwise connected to the housing 122, and the loop pad 134b is omitted. The light source 120 then magnetically attaches to the magnetic inner surface of the associated container. In yet another fastening arrangement, a single piece of double-side-adhesive tape can be used to secure the housing 122 to an inner surface of the associated container.

The disk shape of the light source 120 beneficially fits easily into a round opening, such as the opening formed when the top portion 14 of the hollow pumpkin 12 (FIG. 1) is cut out. The magnetic or hook-and-fastener connector 132 advantageously supports repeated detachment and reattachment to the inner surface without damaging the associated container or the light source 120.

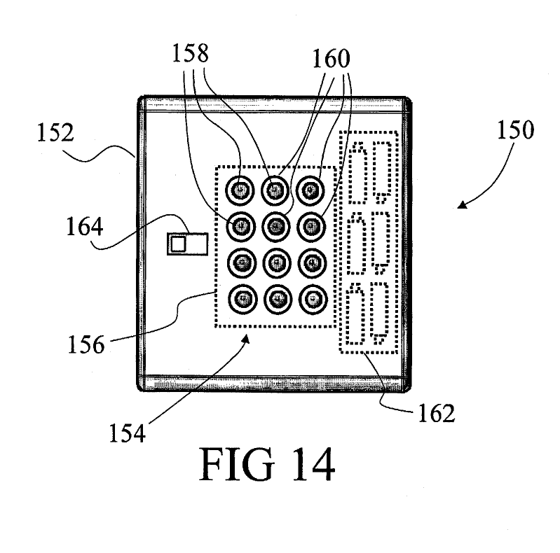

With reference to FIG. 14, yet another exemplary embodiment of an LED light source 150 for use in a jack O'lantern, luminaria, ice sculpture or other decorative light transmissive container includes a flat rectangular housing 152 and an array of LEDs 154. The LED array 154 includes a printed circuit board 156 (shown in phantom) on which are mounted a plurality of LEDs 158, in the exemplary embodiment 150 twelve LEDs arranged in a 3×4 rectangular matrix. The LEDs 158 provide illumination through housing openings 160 that align therewith. The printed circuit board 156 also contains conductive traces and electronic circuitry that drives the LED array 154. The printed circuit board 156 advantageously provides a more convenient platform for mounting and electrically connecting the LED array 154 versus using individual lead frames. The printed circuit board is operatively connected with a battery compartment 162 (shown in phantom) that mechanically and electrically receives associated batteries for powering the LED array 154. Because of the larger number of LEDs versus previous embodiments, the battery compartment 162 preferably accommodates a greater number of batteries, e.g. six batteries. The printed circuit board 156 is further operatively connected with an on/off switch 164 to allow manual effectuating of energizing and deenergizing the LED array 154. The light source 150 also includes a fastening means (not shown) such as the prongs 62 of the light source 20, the hook-and-loop fastener 134 of the light source 120, or the like.

The disclosed light source embodiments 20, 104, 118, 120, 150 are exemplary only. The features of the disclosed embodiments can be combined and interchanged freely. For example, the LED array 154 shown on the rectangular housing 152 can also be arranged on the disk-shaped housing 122. The hook-and-loop fastener 134 can be combined with any of the housings 32, 122, 152, or similarly the disk-shaped housing 122 can be combined with any of the pronged fasteners 62, 106 or the shortened prongs of the embodiment 118. The exemplary circuits 70, 80, 90 or variations thereof can be incorporated into any of the embodiments 20, 104, 118, 120, 150. It is also contemplated to further vary the disclosed embodiments 20, 104, 118, 120, 150 by employing other housing types (e.g., pyramidal, candle-shaped, and the like), other numbers, colors, arrangements, and types of LEDs, different driving circuits, and the like. The light source preferably includes shock-resistant packaging such as epoxies, gels, and other shock absorbing elements known to the art, especially around the LEDs and the electronics, to improve the ruggedness of the light source.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A light for lighting an associated container, the container including at least one of a light transmissive surface and a light transmissive opening, the light comprising:
a housing arrangeable inside the associated container, the housing including a means for receiving electrical power;
at least one light emitting diode arranged on a first side of the housing and electrically connected therewith for receiving energizing electrical power, the at least one light emitting diode producing illumination when energized; and
a fastener arranged on a second side of the housing and adapted to secure the housing to an inner side of the associated container.

2. The light as set forth in claim 1, wherein the associated container includes a hollowed pumpkin having light transmissive openings and wherein the at least one light emitting diode includes:
a first LED that produces a first illumination when energized; and
a second LED that produces a second illumination when energized, said second illumination having a different color than the first illumination.

3. The light as set forth in claim 1, wherein the fastener includes:
at least one projection including a proximate end connected to the second side and a distal end adapted to pressingly secure into an inner surface of the associated container.

4. The light as set forth in claim 2, wherein the first illumination is red in color and the second illumination is amber in color, the first and second illuminations blending to define a composite illumination.

5. The light as set forth in claim 4, further including:
an electronic circuit that imparts an intensity modulation on at least one of the first and second illuminations.

6. The light as set forth in claim 1, wherein the housing comprises a six-sided shape with the first and second sides being non-adjacent.

7. The light as set forth in claim 1, wherein the housing has a substantially puck-shaped form with said first and second sides being substantially planar opposing sides of the puck-shaped form.

8. The light as set forth in claim 1, further including:
an electronic circuit that automatically deenergizes the at least one light emitting diode at a selected time.

9. The light as set forth in claim 1, wherein the fastener is selected from a group consisting of: a projection having a proximate end connecting with the second surface and a distal end adapted to connect to an inner surface of the container and a hook-and-loop fastener.

10. The light as set forth in claim 1, further including:
an electric circuit that modulates the energizing of the at least one LED to produce a modulated illumination.

11. The light as set forth in claim 1, wherein the associated container includes a translucent bag and wherein the fastener includes:
at least one prong extending away from the second side, the at least one prong adapted to puncture a bottom portion of the translucent bag and pressingly secure into a surface on which the translucent bag is arranged.

12. The light as set forth in claim 11, wherein the at least one light emitting diode produces an illumination hue substantially similar to a candlelight hue, the light further including:
an electronic circuit that cooperates with the at least one light emitting diode to simulate flickering candlelight.

13. The light as set forth in claim 1, wherein the at least one LED includes: an array of LEDs arranged on a printed circuit board.

14. A lamp for producing a diffuse or scattered lighting, the lamp comprising:
a container including a light transmissive portion; and
a housing arranged inside the container, the housing including:
at least one LED disposed on a first side of the housing and cooperating with the container to emit diffuse or scattered light from the light transmissive portion, and
a fastening means arranged on a second side of the housing for fastening the housing to an inner side of the container wherein the at least one LED illuminates the interior of the container.

15. The decorative light as set forth in claim 14, wherein the container is selected from a group consisting of: a jack O'lantern, a hollowed pumpkin having a light transmissive portion defined by carved openings, a translucent bag, and an ice sculpture.

16. A lamp which simulates candlelight, said lamp comprising:
an illumination source that produces illumination when energized, said illumination having a spectrum characteristic of candlelight;
supply means for supplying energizing power to the illumination source;
control means for selectively regulating the availability of energizing power from the supply means to the illumination source; and,
a flicker producing device that modulates the illumination from the illumination source so as to emulate candlelight flicker.

17. The lamp of claim 16, wherein the illumination source comprises at least one LED.

18. The lamp of claim 16, wherein the supply means comprises at least one battery.

19. The lamp of claim 16, wherein control means comprises at least one of: a manual on/off switch, said manual on/off switch selectively enabling and disabling the availability of energizing power from the supply means to the illumination source in accordance with a user's positioning of the manual on/off switch; an automatic shut-off device, said automatic shut-off device automatically disabling the availability of energizing power from the supply means to the illumination source; and, an automatic turn-on device, said automatic turn-on device automatically enabling the availability of energizing power from the supply means to the illumination source.

20. The lamp of claim 16, wherein the flicker producing device comprises circuitry that modulates energizing of the illumination source to thus modulate the illumination produced thereby.

21. The lamp of claim 16, further comprising:
fastening means for securing the lamp in a desired location.

22. The lamp of claim 21, said fastening means comprising at least one of: a bolt; an adhesive; a hook-and-loop fastener; a double-sided tape; a magnet; and, a projecting member which pierces a surface when forced into the same.
